(19) United States
(12) Patent Application Publication
(10) Pub. No.: US 2026/0186258 A1
(43) Pub. Date: Jul. 2, 2026

(54) CAMERA OPTICAL LENS

(71) Applicant: Changzhou AAC Raytech Optronics Co., Ltd., Changzhou City (CN)

(72) Inventors: Siyuan Xing, Changzhou (CN); Shunda Zhou, Changzhou (CN)

(21) Appl. No.: 19/339,282

(22) Filed: Sep. 24, 2025

Related U.S. Application Data
(63) Continuation of application No. PCT/CN2024/144539, filed on Dec. 31, 2024.

(51) Int. Cl. G02B 13/00; G02B 9/60

(52) U.S. Cl. CPC G02B 13/0045; G02B 9/60

(57) ABSTRACT

A camera optical lens sequentially includes five lenses from an object side to an image side: a first lens with positive refractive power, a second lens with negative refractive power, a third lens with positive refractive power, a fourth lens with positive refractive power, and a fifth lens with negative refractive power. Following relational expressions are satisfied: 1.30≤f1/f≤1.50; −0.60≤(R5+R6)/(R5−R6)≤−0.35; 0.27≤BF/TTL≤0.34; and 2.10≤R9/R10≤2.70. The camera optical lens has good optical performance and characteristics of large aperture, wide-angle, and ultra-thinness, and is particularly suitable for a mobile phone camera lens assembly and a WEB camera lens composed of camera elements such as CCD, CMOS with high resolution.

### TECHNICAL FIELD

The present disclosure relates to the field of optical lenses, and in particular, to a camera optical lens suitable for handheld terminal devices such as smart phones, digital cameras, and camera devices such as monitors and PC lenses.

### BACKGROUND

In recent years, with the rise of various smart devices, the demand for a miniaturized camera optical lens has gradually increased. Since pixel size of the optical sensor is reduced, and the current electronic product has a development trend of light weight, thinness and being portable, the miniaturized camera optical lens with good imaging quality has become a mainstream of the current market. In order to obtain better imaging quality, a multi-lens structure is mostly used. In addition, with the development of technology and the increase of user's diversified requirements, under the condition that the pixel area of the optical sensor is continuously reduced and the requirements on the imaging quality of the system are continuously improved, a structure with five lenses gradually appears in the lens design. There is an urgent need for a camera optical lens having excellent optical performance such as large aperture, wide-angle and ultra-thinness.

### SUMMARY

In view of the above problems, a main object of the present disclosure is to provide a camera optical lens, which has good optical performance and meets design requirements of large aperture, ultra-thinness and wide-angle.

In order to realize the above object, the technical solution of the present disclosure provides a camera optical lens. The camera optical lens sequentially includes five lenses sequentially from an object side to an image side: a first lens with positive refractive power, a second lens with negative refractive power, a third lens with positive refractive power, a fourth lens with positive refractive power, and a fifth lens with negative refractive power; in which a focal length of the camera optical lens is f, a focal length of the first lens is f1, a curvature radius of an object-side surface of the third lens is R5, a curvature radius of an image-side surface of the third lens is R6, an on-axis distance from an image-side surface of the fifth lens to an image plane is BF, a total optical length from an object-side surface of the first lens to the image plane of the camera optical lens along an optic axis of the camera optical lens is TTL, a curvature radius of an object-side surface of the fifth lens is R9, and a curvature radius of the image-side surface of the fifth lens is R10; and following relational expressions are satisfied: 1.30≤f1/f≤1.50; −0.60≤(R5+R6)/(R5-R6)≤−0.35; 0.27≤BF/TTL≤0.34; and 2.10≤R9/R10≤2.70.

As an improvement, a focal length of the fourth lens is f4, a focal length of the fifth lens is f5, an air gap between the fourth lens and the fifth lens is T45, and a following relational expression is satisfied: 25.00≤(f4-f5)/T45≤60.00.

As an improvement, a center thickness of the third lens along the optic axis is T3, an edge thickness of the third lens is ET3, and a following relational expression is satisfied: 1.50≤T3/ET3≤2.10.

As an improvement, an object-side surface of the first lens is convex in a paraxial region, and an image-side surface of the first lens is concave in the paraxial region; a curvature radius of the object-side surface of the first lens is R1, a curvature radius of the image-side surface of the first lens is R2, an on-axis thickness of the first lens is d1, and following relational expressions are satisfied: −3.25≤(R1+R2)/(R1−R2)≤−2.48; and 0.06≤d1/TTL≤0.09.

As an improvement, an object-side surface of the second lens is concave in a paraxial region, and an image-side surface of the second lens is concave in the paraxial region; a focal length of the second lens is f2, a curvature radius of the object-side surface of the second lens is R3, a curvature radius of the image-side surface of the second lens is R4, and an on-axis thickness of the second lens is d3, and following relational expressions are satisfied: −3.41≤f2/f≤−1.87; 0.47≤(R3+R4)/(R3−R4)≤0.88; and 0.02≤d3/TTL≤0.05.

As an improvement, the object-side surface of the third lens is convex in a paraxial region, and an image-side surface of the third lens is convex in the paraxial region; a focal length of the third lens is f3, an on-axis thickness of the third lens is d5, and following relational expressions are satisfied: 2.00≤f3/f≤3.09; and 0.11≤d5/TTL≤0.12.

As an improvement, an object-side surface of the fourth lens is concave in a paraxial region, and an image-side surface of the fourth lens is convex in the paraxial region; a focal length of the fourth lens is f4, a curvature radius of the object-side surface of the fourth lens is R7, a curvature radius of the image-side surface of the fourth lens is R8, and an on-axis thickness of the fourth lens is d7, and following relational expressions are satisfied:

$$0.74 \leq f 4 / f \leq 0.93 ; 1.87 \leq ( R 7 + R 8 ) / ( R 7 - R 8 ) \leq 2.17 ; and 0.12 \leq d 7 / TTL \leq 0.14 .$$

As an improvement, the object-side surface of the fifth lens is convex in a paraxial region, and the image-side surface of the fifth lens is concave in the paraxial region; a focal length of the fifth lens is f5, and an on-axis thickness of the fifth lens is d9, and following relational expressions are satisfied: −0.98≤f5/f≤−0.65; 2.17≤(R9+R10)/(R9-R10)≤2.71; and 0.10≤d9/TTL≤0.12.

As an improvement, an image height of the camera optical lens is IH, and following relational expression is satisfied: TTL/IH≤1.41.

As an improvement, a field of view of the camera optical lens is FOV, and following relational expression is satisfied: 81.27≤FOV.

The present disclosure has following beneficial effects: the camera optical lens as described in the present disclosure has good optical performance and characteristics of large aperture, wide-angle, and ultra-thinness, and is particularly suitable for a mobile phone camera lens assembly and a WEB camera lens composed of camera elements such as CCD, CMOS with high resolution.

### BRIEF DESCRIPTION OF DRAWINGS

In order to more clearly illustrate technical solutions of embodiments of the present disclosure, the drawings to be used in the embodiments will be briefly described below. he drawings in the following description are some embodiments of the present disclosure. For those skilled in the art, other drawings may also be obtained based on these drawings. In which:

FIG. 1 is a structural schematic diagram of a camera optical lens according to Example 1 of the present disclosure;

FIG. 2 is a schematic diagram of longitudinal aberration of the camera optical lens shown in FIG. 1;

FIG. 3 is a schematic diagram of lateral color of the camera optical lens shown in FIG. 1;

FIG. 4 is a schematic diagram of field curvature and distortion of the camera optical lens shown in FIG. 1;

FIG. 5 is a structural schematic diagram of a camera optical lens according to Example 2 of the present disclosure;

FIG. 6 is a schematic diagram of longitudinal aberration of the camera optical lens shown in FIG. 5;

FIG. 7 is a schematic diagram of lateral color of the camera optical lens shown in FIG. 5;

FIG. 8 is a schematic diagram of field curvature and distortion of the camera optical lens shown in FIG. 5;

FIG. 9 is a structural schematic diagram of a camera optical lens according to Example 3 of the present disclosure;

FIG. 10 is a schematic diagram of longitudinal aberration of the camera optical lens shown in FIG. 9;

FIG. 11 is a schematic diagram of lateral color of the camera optical lens shown in FIG. 9;

FIG. 12 is a schematic diagram of field curvature and distortion of the camera optical lens shown in FIG. 9;

FIG. 13 is a structural schematic diagram of a camera optical lens according to Example 4 of the present disclosure;

FIG. 14 is a schematic diagram of longitudinal aberration of the camera optical lens shown in FIG. 13;

FIG. 15 is a schematic diagram of lateral color of the camera optical lens shown in FIG. 13;

FIG. 16 is a schematic diagram of field curvature and distortion of the camera optical lens shown in FIG. 13;

FIG. 17 is a schematic structural diagram of a camera optical lens according to Comparative Example;

FIG. 18 is a schematic diagram of longitudinal aberration of the camera optical lens shown in FIG. 17;

FIG. 19 is a schematic diagram of lateral color of the camera optical lens shown in FIG. 17; and

FIG. 20 is a schematic diagram of field curvature and distortion of the camera optical lens shown in FIG. 17.

### DESCRIPTION OF EMBODIMENTS

In order to more clearly illustrate objectives, technical solutions, and advantages of embodiments of the present disclosure, the following will provide a detailed description of various embodiments of the present disclosure in combination with the drawings. However, it should be understood by those skilled in the art that in each embodiment of the present disclosure, many technical details are presented to help readers better understand the present disclosure. However, even without these technical details and various changes and modifications based on the following embodiments, the technical solutions required to be protected by the present disclosure can still be achieved.

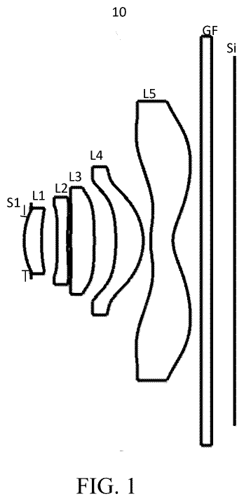

Referring to the figures, the technical solution of the present disclosure provides camera optical lenses 10, 20, 30 and 40. FIG. 1, FIG. 5, FIG. 9 and FIG. 13 show camera optical lenses 10, 20, 30 and 40 according to the present disclosure, and the camera optical lenses 10, 20, 30 and 40 include five lenses. Specifically, the camera optical lens sequentially includes from an object side to an image side: an aperture S1, a first lens L1, a second lens L2, a third lens L3, a fourth lens L4 and a fifth lens L5. An optical element such as an optical filter GF may be provided between the fifth lens L5 and the image plane Si.

The first lens L1 is made of plastic material, the second lens L2 is made of plastic material, the third lens L3 is made of plastic material, the fourth lens L4 is made of plastic material, and the fifth lens L5 is made of plastic material. The lenses may also be made of other materials.

It is defined that a focal length of the camera optical lens 10 is f, a focal length of the first lens L1 is f1, and a following relational expression is satisfied: 1.30≤f1/f≤1.50, which specifies a ratio of the focal length of the first lens to a total focal length of the system. By reasonably distributing the focal length of the distribution system, the system has better imaging quality and lower sensitivity, and the positive refractive power of the first lens L1 is specified. When the lower limit is exceeded, although it is beneficial to the development of the lens to ultra-thinness, the positive refractive power of the first lens L1 may be too strong, and it is difficult to correct the problems such as aberration, while it is not beneficial to the development of the lens to wide-angle. On the contrary, when the upper limit is exceeded, the positive refractive power of the first lens becomes too weak, and the lens is difficult to develop toward ultra-thinness.

It is defined that a curvature radius of an object-side surface of the third lens is R5, a curvature radius of an image-side surface of the third lens is R6, −0.60≤(R5+R6)/(R5−R6)≤−0.35, and the relational expression specifies the shape of the third lens, which is beneficial to correcting astigmatism and distortion of the camera lens, so that distortion|<2.5%, and the possibility of vignetting generation is reduced.

It is defined that an on-axis distance from an image-side surface of the fifth lens to an image-surface of the fifth lens is BF, a total optical length from the object-side surface of the first lens to an image plane of the camera optical lens along an optic axis of the camera optical lens is TTL, 0.27≤BF/TTL≤0.34, on the basis of achieving miniaturization, a longer back focal length is beneficial to the assembly of the module, while it may also effectively control the total length of the optical system.

It is defined that a curvature radius of the object-side surface of the fifth lens is defined as R9, a curvature radius of the image-side surface of the fifth lens is R10, 2.10≤R9/R10≤2.70, and the surface shape of the fifth lens is reasonably controlled, which is beneficial to reducing the sensitivity of the system, improving the manufacturing yield by reducing the molding difficulty, while also reducing stray light generated by the lens and improving the imaging quality of the lens.

It is defined that a focal length of the fourth lens is f4, a focal length of the fifth lens is f5, an air gap between the fourth lens and the fifth lens is T45, 25.00≤(f4−f5)/T45≤60.00, and by reasonably distributing a light focal length of the system, the system has better imaging quality and lower sensitivity.

It is defined that a center thickness of the third lens on the optic axis is T3, an edge thickness of the third lens is ET3, 1.50≤T3/ET3≤2.10, and a ratio of the center thickness to the edge thickness of the third lens is specified, which is beneficial to processing and assembling of the lens.

When the above relational expressions are satisfied, the camera optical lenses 10, 20, 30, and 40 have good optical performance and may satisfy the design requirements of large aperture, wide-angle and ultra-thinness; according to the characteristics of the camera optical lenses 10, 20, 30, and 40, the camera optical lenses 10, 20, 30, and 40 are particularly suitable for mobile phone camera lens assembly and the WEB camera lens composed of camera elements such as CCD and CMOS for high pixels.

Based on the above relational expressions and the achievable functions, the characteristics of each lens are further defined as follows.

An object-side surface of the first lens L1 is convex in a paraxial region, an image-side surface of the first lens L1 is concave in the paraxial region, and the first lens L1 has positive refractive power. The object-side surface and the image-side surface of the first lens L1 may also be provided with other concave and convex distributions.

It is defined that a central curvature radius of the object-side surface of the first lens L1 is R1, a central curvature radius of the image-side surface of the first lens L1 is R2, and a following rational expression is satisfied: −3.25≤(R1+R2)/(R1−R2)≤−2.48, which reasonably controls the shape of the first lens L1, so that the first lens L1 may effectively correct the spherical aberration of the system.

An on-axis thickness of the first lens L1 is d1, a total optical length from an object-side surface of the first lens to an image plane of the camera optical lens along an optic axis of the camera optical lens 10 is TTL, and a following rational expression is satisfied: 0.06≤d1/TTL≤0.09. Within the range of the relational expression, it is beneficial to achieving ultra-thinness.

An object-side surface of the second lens L2 is concave in a paraxial region, an image-side surface of the second lens L2 is concave in the paraxial region, and the second lens L2 has negative refractive power. The object-side surface and the image-side surface of the second lens L2 may also be provided with other concave and convex distributions.

It is defined that the focal length of the camera optical lens 10 is f, a focal length of the second lens L2 is f2, and a following relational expression is satisfied: −3.41≤f2/f≤−1.87, by controlling the positive refractive power of the second lens L2 within a reasonable range, it is beneficial to correct the aberration of the optical system. A central curvature radius of an object-side surface of the second lens L2 is R3, a central curvature radius of an image-side surface of the second lens L2 is R4, and a following relational expression is satisfied: 0.47≤(R3+R4)/(R3−R4)≤0.88, which specifies a shape of the second lens L2. Within the above range, as lenses develop towards ultra-thinness and wide-angle, it is beneficial to correct the problem of axial chromatic aberration. An on-axis thickness of the second lens L2 is d3, a total optical length from an object-side surface of the first lens to an image plane of the camera optical lens along an optic axis of the camera optical lens 10 is TTL, and a following relational expression is satisfied: 0.02≤d3/TTL≤0.05. Within the range of the relational expression, it is beneficial to achieving ultra-thinness. An object-side surface of the third lens L3 is convex in a paraxial region, an image-side surface of the third lens L3 is convex in the paraxial region, and the third lens L3 has positive refractive power. The object-side surface and the image-side surface of the third lens L3 may be provided with other concave and convex distributions.

It is defined that the focal length of the camera optical lens 10 is f, a focal length of the third lens L3 is f3, and a following relational expression is satisfied: 2.00≤f3/f≤3.09. By reasonably distributing the refractive power, the system has better imaging quality and lower sensitivity. An on-axis thickness of the third lens L3 is d5, the total optical length from the object-side surface of the first lens to an image plane of the camera optical lens along an optic axis of the camera optical lens 10 is TTL, and a following relational expression is satisfied: 0.11≤d5/TTL≤0.12. Within the range of the relational expression, it is beneficial to achieving ultra-thinness.

An object-side surface of the fourth lens L4 is concave in the paraxial region, an image-side surface of the fourth lens L4 is convex in the paraxial region, and the fourth lens L4 has positive refractive power. The object-side surface and the image-side surface of the fourth lens L4 may also be provided with other concave and convex distributions.

It is defined that the focal length of the camera optical lens 10 is f, a focal length of the fourth lens L4 is f4, and a following relational expression is satisfied: 0.74≤f4/f≤0.93, by reasonably distributing the refractive power, the system has better imaging quality and lower sensitivity. A central curvature radius of the object-side surface of the fourth lens L4 is R7, a central curvature radius of the image-side surface of the fourth lens L4 is R8, and a following relational expression is satisfied: 1.87≤(R7+R8)/(R7−R8)≤2.17, which specifies a shape of the fourth lens L4, within the range, as lenses develop towards ultra-thinness and wide-angle, it is beneficial to correct the problem of aberration of off-axis aberration. An on-axis thickness of the fourth lens L4 is d7, the total optical length from the object-side surface of the first lens to an image plane of the camera optical lens along an optic axis of the camera optical lens 10 is TTL, and a following relational expression is satisfied: 0.12≤d7/TTL≤0.14. Within the range of the relational expression, it is beneficial to achieving ultra-thinness.

An object-side surface of the fifth lens L5 is convex in the paraxial region, an image-side surface of the fifth lens L5 is concave in the paraxial region, and the fifth lens L5 has negative refractive power. The object-side surface and the image-side surface of the fifth lens L5 may also be provided with other concave and convex distributions.

It is defined that the focal length of the camera optical lens 10 is f, a focal length of the fifth lens L5 is f5, and a following relational expression is satisfied: −0.98≤f5/f≤−0.65, and the limitation on the fifth lens L5 may effectively make the light angle of the camera optical lens 10 gentle and reduce the tolerance sensitivity. A central curvature radius of the object-side surface of the fifth lens L5 is R9, a central curvature radius of the image-side surface of the fifth lens L5 is R10, and a following relational expression is satisfied: 2.17≤(R9+R10)/(R9−R10)≤2.71, which specifies a shape of the fifth lens L5. Within the above range, as lenses develop towards ultra-thinness and wide-angle, it is beneficial to correct the problem of aberration of off-axis aberration. An on-axis thickness of the fifth lens L5 is d9, the total optical length from the object-side surface of the first lens to an image plane of the camera optical lens along an optic axis of the camera optical lens 10 is TTL, and a following relational expression is satisfied: 0.10≤d9/TTL≤0.12. Within the range of the relational expression, it is beneficial to achieving ultra-thinness.

The image height at 1.0 field of view of the camera optical lens 10 is IH, and the total optical length from the object-side surface of the first lens to an image plane of the camera optical lens along an optic axis of the camera optical lens is TTL, and a following relational expression is satisfied: TTL/IH≤1.41, which is beneficial for achieving ultra-thinness. A field of view FOV at 1.0 field of view of the camera optical lens 10 is greater than or equal to 81.27°, thereby achieving wide-angle.

The camera optical lens of the present disclosure will be described below with examples. The reference signs recited in each embodiment are shown below. The units of the focal length, the on-axis distance, the central curvature radius, and the on-axis thickness are mm.

TTL refers to the total optical length from the object-side surface of the first lens to an image plane of the camera optical lens along an optic axis of the camera optical lens (the on-axis distance from the object-side surface of the first lens L1 to the image plane Si), in mm.

F-number FNO: a ratio of the effective focal length of the camera optical lens to the entrance pupil diameter.

Image height IH at 1.0 field of view: a height of the field of view corresponding to the active pixel of the sensor (that is, half of the diagonal length of the active pixel region of the sensor).

Field of view FOV at 1.0 field of view: a field of view corresponding to the active pixel of the sensor;

Image height IHm at MIC (Microscope Infrared Spectroscopy) field of view: a height of the field of view expanding beyond 1.0 field of view for preventing assembly deviation.

Field of view FOVm at MIC field of view: a field of view corresponding to an image height at MIC field of view.

Optionally, the object-side surface and/or the image-side surface of the lens may be further provided with an inflection point and/or an arrest point, so as to meet high-quality imaging requirements.

The technical solutions of the present disclosure will be specifically described in four Examples. Meanwhile, Comparative Example is provided as a reference, and the technical effects of the present disclosure cannot be achieved when the ranges of the above relational expressions are exceeded.

### Example 1

Table 1 and Table 2 show design data of the camera optical lens 10 according to Example 1 of the present disclosure.

TABLE 1

| | R | d | | nd | | vd | |
|---|---|---|---|---|---|---|---|
| S1 | ∞ | d0= | −0.145 | | | | |
| R1 | 1.407 | d1= | 0.350 | nd1 | 1.5444 | vd1 | 55.82 |
| R2 | 3.192 | d2= | 0.320 | | | | |
| R3 | −69.139 | d3= | 0.210 | nd2 | 1.6700 | vd2 | 19.39 |
| R4 | 4.678 | d4= | 0.063 | | | | |
| R5 | 5.114 | d5= | 0.476 | nd3 | 1.5444 | vd3 | 55.82 |
| R6 | −13.811 | d6= | 0.437 | | | | |
| R7 | −3.328 | d7= | 0.555 | nd4 | 1.5444 | vd4 | 55.82 |
| R8 | −1.111 | d8= | 0.148 | | | | |
| R9 | 1.499 | d9= | 0.453 | nd5 | 1.5346 | vd5 | 55.69 |
| R10 | 0.684 | d10= | 0.570 | | | | |
| R11 | ∞ | d11= | 0.210 | ndg | 1.5168 | vdg | 64.17 |
| R12 | ∞ | d12= | −0.145 | | | | |

The meaning of each reference sign is as follows:
S1: aperture;
R: curvature radius at the center of an optical surface;
R1: central curvature radius of the object-side surface of the first lens L1;
R2: central curvature radius of the image-side surface of the first lens L1;
R3: central curvature radius of the object-side surface of the second lens L2;
R4: central curvature radius of the image-side surface of the second lens L2;
R5: central curvature radius of the object-side surface of the third lens L3;
R6: central curvature radius of the image-side surface of the third lens L3;
R7: central curvature radius of the object-side surface of the fourth lens L4;
R8: central curvature radius of the image-side surface of the fourth lens L4;
R9: central curvature radius of the object-side surface of the fifth lens L5;
R10: central curvature radius of the image-side surface of the fifth lens L5;
R11: central curvature radius of the object-side surface of the optical filter GF;
R12: central curvature radius of the image-side surface of the optical filter GF;
d: on-axis thickness of lenses, on-axis distance between lenses;
d0: on-axis distance from the aperture S1 to the object-side surface of the first lens L1;
d1: on-axis thickness of the first lens L1;
d2: on-axis distance from the image-side surface of the first lens L1 to the object-side surface of the second lens L2;
d3: on-axis thickness of the second lens L2;
d4: on-axis distance from the image-side surface of the second lens L2 to the object-side surface of the third lens L3;
d5: on-axis thickness of the third lens L3;
d6: on-axis distance from the image-side surface of the third lens L3 to the object-side surface of the fourth lens L4;
d7: on-axis thickness of the fourth lens L4;
d8: on-axis distance from the image-side surface of the fourth lens L4 to the object-side surface of the fifth lens L5;
d9: on-axis thickness of the fifth lens L5;
d10: on-axis distance from the image-side surface of the fifth lens L5 to the object-side surface of the optical filter GF;
d11: on-axis thickness of the optical filter GF;
d12: on-axis distance from the image-side surface of the optical filter GF to the image plane Si;
nd: refractive index of d line (d line corresponds to green light with a wavelength of 550 nm);
nd1: refractive index of d line of the first lens L1;
nd2: refractive index of d line of the second lens L2;
nd3: refractive index of d line of the third lens L3;
nd4: refractive index of d line of the fourth lens L4;
nd5: refractive index of d line of the fifth lens L5;
ndg: refractive index of d line of the optical filter GF;
vd: abbe number;
vd1: abbe number of the first lens L1;
vd2: abbe number of the second lens L2;
vd3: abbe number of the third lens L3;
vd4: abbe number of the fourth lens L4;
vd5: abbe number of the fifth lens L5; and
vdg: abbe number of the optical filter GF.

Table 2 shows aspheric data of each lens in the camera optical lens 10 according to Example 1 of the present disclosure.

TABLE 2

| | Conic Coefficient | Aspheric Coefficient | | | | | | |
|---|---|---|---|---|---|---|---|---|
| | k | A4 | A6 | A8 | A10 | A12 | A14 | A16 |
| R1 | 1.9026E−01 | 2.0572E−02 | 1.6629E−02 | 4.9095E−01 | −4.9809E+00 | 2.3571E+01 | −5.5445E+01 | 4.9958E+01 |
| R2 | 1.4428E+00 | 1.1494E−02 | −1.7490E−01 | 2.9199E+00 | −3.1724E+01 | 2.0089E+02 | −7.7437E+02 | 1.7682E+03 |
| R3 | −3.7251E+02 | −1.9739E−01 | 3.5069E−01 | −5.9792E−01 | −1.5937E+01 | 1.3587E+02 | −5.4754E+02 | 1.2134E+03 |
| R4 | 1.8990E+00 | −3.6978E−01 | 1.5853E+00 | −6.4202E+00 | 1.7845E+01 | −3.0994E+01 | 2.5657E+01 | 5.0535E+00 |
| R5 | −3.1667E+01 | −3.9471E−01 | 2.2357E+00 | −1.9787E+01 | 1.5649E+02 | −9.0977E+02 | 3.7743E+03 | −1.1306E+04 |
| R6 | 8.8180E+01 | −1.1907E−01 | −4.4431E−01 | 5.1168E+00 | −4.0365E+01 | 2.1508E+02 | −7.9339E+02 | 2.0690E+03 |
| R7 | −2.3965E+00 | −1.1356E−01 | 2.1218E+00 | −2.6942E+01 | 1.8186E+02 | −8.0476E+02 | 2.4606E+03 | −5.3326E+03 |
| R8 | −1.2171E+00 | −5.7274E−02 | −1.2903E−01 | 1.2420E+00 | −6.3917E+00 | 1.9121E+01 | −3.8048E+01 | 5.4215E+01 |
| R9 | −1.0270E+00 | −7.0729E−01 | 4.9295E−01 | −6.3062E−03 | −3.3125E−01 | 3.6370E−01 | −2.2822E−01 | 9.6797E−02 |
| R10 | −1.0102E+00 | −1.0460E+00 | 1.3531E+00 | −1.4284E+00 | 1.1616E+00 | −7.1411E−01 | 3.2999E−01 | −1.1442E−01 |
| | Conic Coefficient | Aspheric Coefficient | | | | | | |
| | k | A18 | A20 | A22 | A24 | A26 | A28 | A30 |
| R1 | 1.9026E−01 | 2.4385E+01 | −5.4196E+01 | 0.0000E+00 | 0.0000E+00 | 0.0000E+00 | 0.0000E+00 | 0.0000E+00 |
| R2 | 1.4428E+00 | −2.2008E+03 | 1.1455E+03 | 0.0000E+00 | 0.0000E+00 | 0.0000E+00 | 0.0000E+00 | 0.0000E+00 |
| R3 | −3.7251E+02 | −1.4233E+03 | 6.8513E+02 | 0.0000E+00 | 0.0000E+00 | 0.0000E+00 | 0.0000E+00 | 0.0000E+00 |
| R4 | 1.8990E+00 | −2.4854E+01 | 1.2610E+01 | 0.0000E+00 | 0.0000E+00 | 0.0000E+00 | 0.0000E+00 | 0.0000E+00 |
| R5 | −3.1667E+01 | 2.4784E+04 | −3.9990E+04 | 4.7202E+04 | −3.9767E+04 | 2.2656E+04 | −7.8080E+03 | 1.2255E+03 |
| R6 | 8.8180E+01 | −3.8684E+03 | 5.1978E+03 | −4.9648E+03 | 3.2775E+03 | −1.4147E+03 | 3.5710E+02 | −3.9698E+01 |
| R7 | −2.3965E+00 | 8.2943E+03 | −9.2750E+03 | 7.3812E+03 | −4.0732E+03 | 1.4795E+03 | −3.1778E+02 | 3.0553E+01 |
| R8 | −1.2171E+00 | −5.7166E+01 | 4.4845E+01 | −2.5700E+01 | 1.0354E+01 | −2.7541E+00 | 4.3162E−01 | −3.0070E−02 |
| R9 | −1.0270E+00 | −2.8911E−02 | 6.1137E−03 | −9.0254E−04 | 8.9858E−05 | −5.6390E−06 | 1.9415E−07 | −2.5624E−09 |
| R10 | −1.0102E+00 | 2.9664E−02 | −5.7001E−03 | 7.9796E−04 | −7.8898E−05 | 5.2107E−06 | −2.0593E−07 | 3.6783E−09 |

For convenience, the aspherical surface of each lens surface uses the aspherical surface shown in following formula (1). However, the present disclosure is not limited to the aspherical polynomial form shown in formula (1).

$$z = ( c {r}^{2} ) / \{ 1 + {[ 1 ( k + 1 ) ( {c}^{2} {r}^{2} ) ]}^{1 / 2} \} + A 4 {r}^{4} + A 6 {r}^{6} + A 8 {r}^{8} + A 10 {r}^{10} + A 12 {r}^{12} + A 14 {r}^{14} + A 16 {r}^{16} + A 18 {r}^{18} + A 20 {r}^{20} + A 22 {r}^{22} + A 24 {r}^{24} + A 26 {r}^{26} + A 28 {r}^{28} + A 30 {r}^{30} \qquad ( 1 )$$

k is a conic coefficient, A4, A6, A8, A10, A12, A14, A16, A18, A20, A22, A24, A26, A28 and A30 are aspherical coefficients, c is a curvature at a center of an optical surface, ris a vertical distance between a point on an aspherical curve and an optic axis, and z is an aspherical depth (a vertical distance between a point on the aspherical surface having a distance r from the optical axis, and a tangent plane tangent to a vertex on the aspherical optical axis).

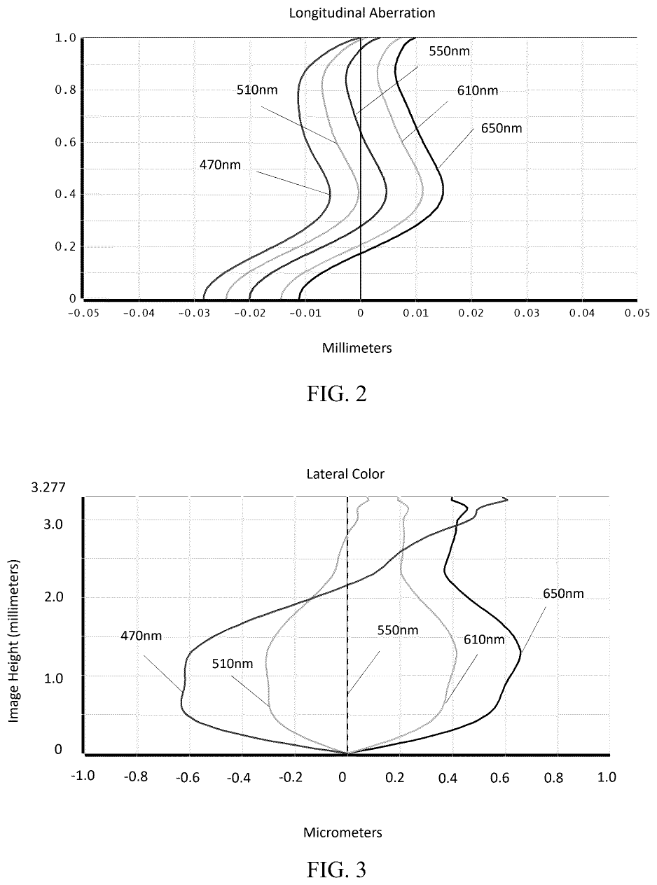

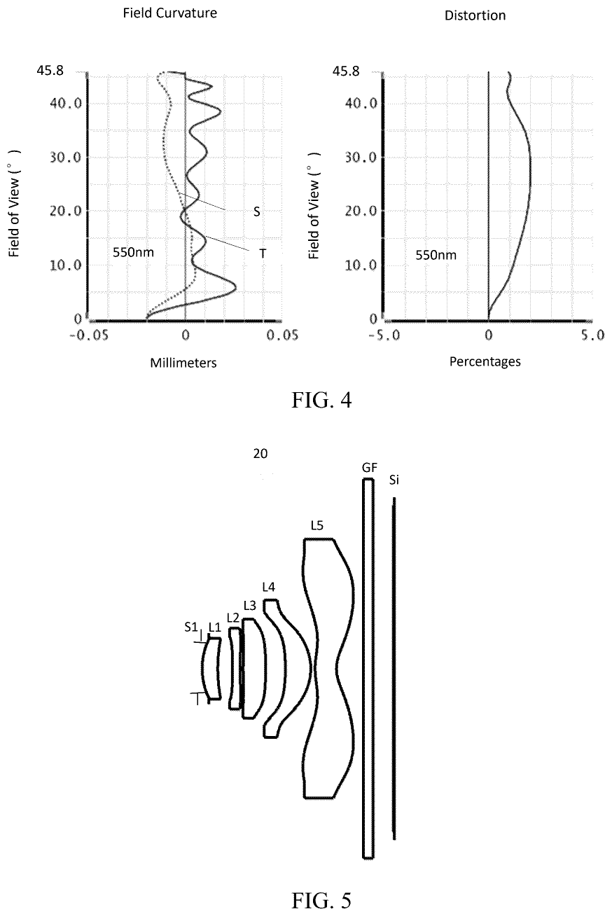

FIG. 2 and FIG. 3 respectively show longitudinal aberration and lateral color of light with wavelengths of 650 nm, 610 nm, 550 nm, 510 nm, and 470 nm after passing through the camera optical lens 10 according to Example 1. FIG. 4 shows field curvature and distortion of light with a wavelength of 550 nm after passing through the camera optical lens 10 according to the first embodiment, the field curvature S in FIG. 4 is a field curvature in the sagittal direction, and T is a field curvature in the meridian direction.

In this Example, the entrance pupil diameter ENPD of the camera optical lens 10 is 1.276 mm, the image height IH at 1.0 field of view is 3.277 mm, the field of view FOV at 1.0 field of view is 91.64°, the image height IHm at MIC field of view is 3.349 mm, and the field of view FOVm at MIC field of view is 93.51°. The camera optical lens 10 meets the design requirements of large aperture, wide-angle and ultra-thinness, effectively correcting both the on-axis and off-axis chromatic aberrations thereof, and has excellent optical performance.

### Example 2

The meaning of the reference signs of Example 2 is the same as that of Example 1, and only differences are listed below.

FIG. 5 shows a camera optical lens 20 according to Example 2 of the present disclosure.

Table 3 and Table 4 show design data of a camera optical lens 20 according to Example 2 of the present disclosure.

TABLE 3

| | R | d | | nd | | vd | |
|---|---|---|---|---|---|---|---|
| S1 | ∞ | d0= | −0.148 | | | | |
| R1 | 1.447 | d1= | 0.341 | nd1 | 1.5444 | vd1 | 55.82 |
| R2 | 3.256 | d2= | 0.320 | | | | |
| R3 | −25.707 | d3= | 0.167 | nd2 | 1.6700 | vd2 | 19.39 |
| R4 | 5.458 | d4= | 0.068 | | | | |
| R5 | 5.277 | d5= | 0.490 | nd3 | 1.5444 | vd3 | 55.82 |
| R6 | −10.972 | d6= | 0.433 | | | | |
| R7 | −3.651 | d7= | 0.555 | nd4 | 1.5444 | vd4 | 55.82 |
| R8 | −1.107 | d8= | 0.095 | | | | |
| R9 | 1.470 | d9= | 0.465 | nd5 | 1.5346 | vd5 | 55.69 |
| R10 | 0.676 | d10= | 0.589 | | | | |
| R11 | ∞ | d11= | 0.210 | ndg | 1.5168 | vdg | 64.17 |
| R12 | ∞ | d0= | −0.148 | | | | |

Table 4 shows aspheric data of each lens in the camera optical lens 20 according to Example 2 of the present disclosure.

### [Table 4]

TABLE 4

| | Conic Coefficient | Aspheric Coefficient | | | | | | |
|---|---|---|---|---|---|---|---|---|
| | k | A4 | A6 | A8 | A10 | A12 | A14 | A16 |
| R1 | 1.9026E−01 | 2.0572E−02 | 1.6629E−02 | 4.9095E−01 | −4.9809E+00 | 2.3571E+01 | −5.5445E+01 | 4.9958E+01 |
| R2 | 1.4428E+00 | 1.1494E−02 | −1.7490E−01 | 2.9199E+00 | −3.1724E+01 | 2.0089E+02 | −7.7437E+02 | 1.7682E+03 |
| R3 | −3.7251E+02 | −1.9739E−01 | 3.5069E−01 | −5.9792E−01 | −1.5937E+01 | 1.3587E+02 | −5.4754E+02 | 1.2134E+03 |
| R4 | 1.8990E+00 | −3.6978E−01 | 1.5853E+00 | −6.4202E+00 | 1.7845E+01 | −3.0994E+01 | 2.5657E+01 | 5.0535E+00 |
| R5 | −3.1667E+01 | −3.9471E−01 | 2.2357E+00 | −1.9787E+01 | 1.5649E+02 | −9.0977E+02 | 3.7743E+03 | −1.1306E+04 |
| R6 | 8.8180E+01 | −1.1907E−01 | −4.4431E−01 | 5.1168E+00 | −4.0365E+01 | 2.1508E+02 | −7.9339E+02 | 2.0690E+03 |
| R7 | −2.3965E+00 | −1.1356E−01 | 2.1218E+00 | −2.6942E+01 | 1.8186E+02 | −8.0476E+02 | 2.4606E+03 | −5.3326E+03 |
| R8 | −1.2171E+00 | −5.7274E−02 | −1.2903E−01 | 1.2420E+00 | −6.3917E+00 | 1.9121E+01 | −3.8048E+01 | 5.4215E+01 |
| R9 | −1.0270E+00 | −7.0729E−01 | 4.9295E−01 | −6.3062E−03 | −3.3125E−01 | 3.6370E−01 | −2.2822E−01 | 9.6797E−02 |
| R10 | −1.0102E+00 | −1.0460E+00 | 1.3531E+00 | −1.4284E+00 | 1.1616E+00 | −7.1411E−01 | 3.2999E−01 | −1.1442E−01 |
| | Conic Coefficient | Aspheric Coefficient | | | | | | |
| | k | A18 | A20 | A22 | A24 | A26 | A28 | A30 |
| R1 | 1.9026E−01 | 2.4385E+01 | −5.4196E+01 | 0.0000E+00 | 0.0000E+00 | 0.0000E+00 | 0.0000E+00 | 0.0000E+00 |
| R2 | 1.4428E+00 | −2.2008E+03 | 1.1455E+03 | 0.0000E+00 | 0.0000E+00 | 0.0000E+00 | 0.0000E+00 | 0.0000E+00 |
| R3 | −3.7251E+02 | −1.4233E+03 | 6.8513E+02 | 0.0000E+00 | 0.0000E+00 | 0.0000E+00 | 0.0000E+00 | 0.0000E+00 |
| R4 | 1.8990E+00 | −2.4854E+01 | 1.2610E+01 | 0.0000E+00 | 0.0000E+00 | 0.0000E+00 | 0.0000E+00 | 0.0000E+00 |
| R5 | −3.1667E+01 | 2.4784E+04 | −3.9990E+04 | 4.7202E+04 | −3.9767E+04 | 2.2656E+04 | −7.8080E+03 | 1.2255E+03 |
| R6 | 8.8180E+01 | −3.8684E+03 | 5.1978E+03 | −4.9648E+03 | 3.2775E+03 | −1.4147E+03 | 3.5710E+02 | −3.9698E+01 |
| R7 | −2.3965E+00 | 8.2943E+03 | −9.2750E+03 | 7.3812E+03 | −4.0732E+03 | 1.4795E+03 | −3.1778E+02 | 3.0553E+01 |
| R8 | −1.2171E+00 | −5.7166E+01 | 4.4845E+01 | −2.5700E+01 | 1.0354E+01 | −2.7541E+00 | 4.3162E−01 | −3.0070E−02 |
| R9 | −1.0270E+00 | −2.8911E−02 | 6.1137E−03 | −9.0254E−04 | 8.9858E−05 | −5.6390E−06 | 1.9415E−07 | −2.5624E−09 |
| R10 | −1.0102E+00 | 2.9664E−02 | −5.7001E−03 | 7.9796E−04 | −7.8898E−05 | 5.2107E−06 | −2.0593E−07 | 3.6783E−09 |

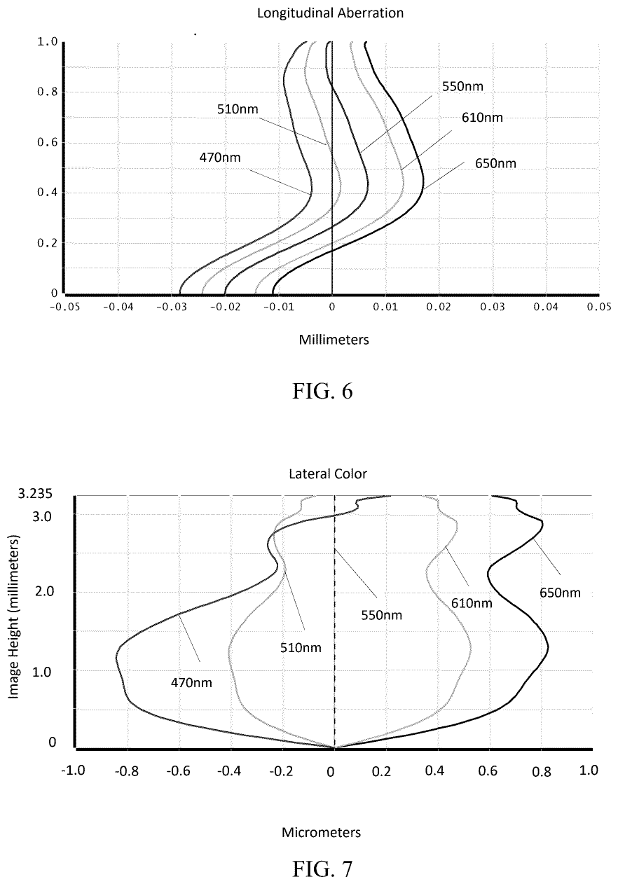

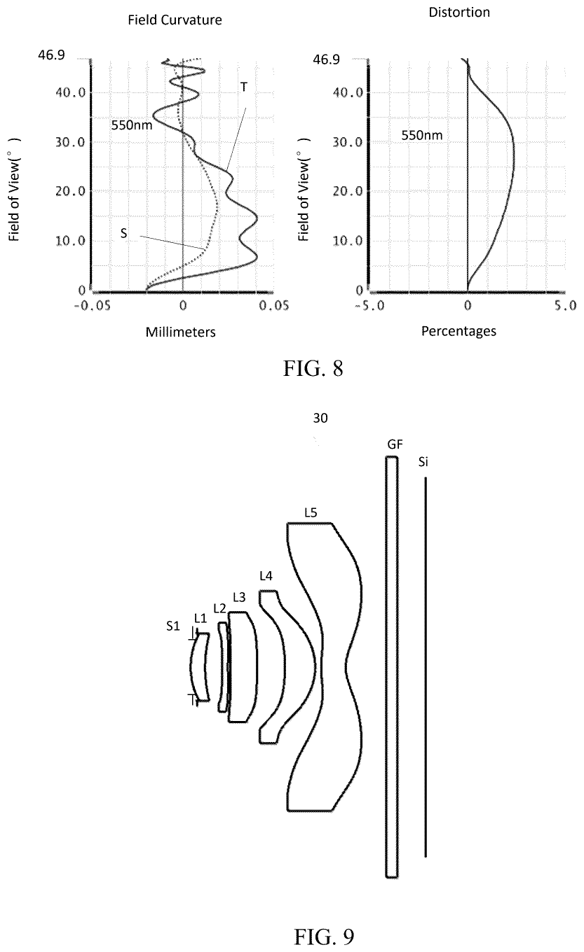

FIG. 6 and FIG. 7 respectively show longitudinal aberration and lateral color of light with wavelengths of 650 nm, 610 nm, 550 nm, 510 nm and 470 nm after passing through the camera optical lens 20 according to Example 2. FIG. 8 shows field curvature and distortion of light with a wavelength of 550 nm after passing through the camera optical lens 20 according to Example 2. The field curvature S in FIG. 8 is the field curvature in a sagittal direction, and Tis the field curvature in a meridian direction.

In this Example, the entrance pupil diameter ENPD of the camera optical lens 20 is 1.276 mm, the image height IH at 1.0 field of view is 3.235 mm, the field of view FOV at 1.0 field of view is 93.71°, the image height IHm at MIC field of view is 3.302 mm, and the field of view FOVm at MIC field of view is 95.06°. The camera optical lens 20 meets the design requirements of large aperture, wide-angle and ultra-thinness, effectively correcting both the on-axis and off-axis chromatic aberrations thereof, and has excellent optical performance.

### Example 3

The meaning of the reference signs of Example 3 is the same as that of Example 1.

FIG. 9 shows a camera optical lens 30 according to Example 3 of the present disclosure.

Table 5 and Table 6 show design data of the camera optical lens 30 according to the Example 3 of the present disclosure.

TABLE 5

| | R | d | | nd | | vd | |
|---|---|---|---|---|---|---|---|
| S1 | ∞ | d0= | −0.130 | | | | |
| R1 | 1.347 | d1= | 0.284 | nd1 | 1.5444 | vd1 | 55.82 |
| R2 | 2.548 | d2= | 0.332 | | | | |
| R3 | −64.969 | d3= | 0.115 | nd2 | 1.6700 | vd2 | 19.39 |
| R4 | 9.877 | d4= | 0.047 | | | | |
| R5 | 7.781 | d5= | 0.524 | nd3 | 1.5444 | vd3 | 55.82 |
| R6 | −31.125 | d6= | 0.550 | | | | |
| R7 | −2.975 | d7= | 0.595 | nd4 | 1.5444 | vd4 | 55.82 |
| R8 | −1.074 | d8= | 0.117 | | | | |
| R9 | 1.901 | d9= | 0.482 | nd5 | 1.5346 | vd5 | 55.69 |
| R10 | 0.705 | d10= | 0.800 | | | | |
| R11 | ∞ | d11= | 0.210 | ndg | 1.5168 | vdg | 64.17 |
| R12 | ∞ | d12= | 0.558 | | | | |

Table 6 shows aspheric data of each lens in the camera optical lens 30 according to Example 3 of the present disclosure.

TABLE 6

| | Conic Coefficient | Aspheric Coefficient | | | | | | |
|---|---|---|---|---|---|---|---|---|
| | k | A4 | A6 | A8 | A10 | A12 | A14 | A16 |
| R1 | 1.9026E−01 | 2.0572E−02 | 1.6629E−02 | 4.9095E−01 | −4.9809E+00 | 2.3571E+01 | −5.5445E+01 | 4.9958E+01 |
| R2 | 1.4428E+00 | 1.1494E−02 | −1.7490E−01 | 2.9199E+00 | −3.1724E+01 | 2.0089E+02 | −7.7437E+02 | 1.7682E+03 |
| R3 | −3.7251E+02 | −1.9739E−01 | 3.5069E−01 | −5.9792E−01 | −1.5937E+01 | 1.3587E+02 | −5.4754E+02 | 1.2134E+03 |
| R4 | 1.8990E+00 | −3.6978E−01 | 1.5853E+00 | −6.4202E+00 | 1.7845E+01 | −3.0994E+01 | 2.5657E+01 | 5.0535E+00 |
| R5 | −3.1667E+01 | −3.9471E−01 | 2.2357E+00 | −1.9787E+01 | 1.5649E+02 | −9.0977E+02 | 3.7743E+03 | −1.1306E+04 |
| R6 | 8.8180E+01 | −1.1907E−01 | −4.4431E−01 | 5.1168E+00 | −4.0365E+01 | 2.1508E+02 | −7.9339E+02 | 2.0690E+03 |
| R7 | −2.3965E+00 | −1.1356E−01 | 2.1218E+00 | −2.6942E+01 | 1.8186E+02 | −8.0476E+02 | 2.4606E+03 | −5.3326E+03 |
| R8 | −1.2171E+00 | −5.7274E−02 | −1.2903E−01 | 1.2420E+00 | −6.3917E+00 | 1.9121E+01 | −3.8048E+01 | 5.4215E+01 |
| R9 | −1.0270E+00 | −7.0729E−01 | 4.9295E−01 | −6.3062E−03 | −3.3125E−01 | 3.6370E−01 | −2.2822E−01 | 9.6797E−02 |
| R10 | −1.0102E+00 | −1.0460E+00 | 1.3531E+00 | −1.4284E+00 | 1.1616E+00 | −7.1411E−01 | 3.2999E−01 | −1.1442E−01 |
| | Conic Coefficient | Aspheric Coefficient | | | | | | |
| | k | A18 | A20 | A22 | A24 | A26 | A28 | A30 |
| R1 | 1.9026E−01 | 2.4385E+01 | −5.4196E+01 | 0.0000E+00 | 0.0000E+00 | 0.0000E+00 | 0.0000E+00 | 0.0000E+00 |
| R2 | 1.4428E+00 | −2.2008E+03 | 1.1455E+03 | 0.0000E+00 | 0.0000E+00 | 0.0000E+00 | 0.0000E+00 | 0.0000E+00 |
| R3 | −3.7251E+02 | −1.4233E+03 | 6.8513E+02 | 0.0000E+00 | 0.0000E+00 | 0.0000E+00 | 0.0000E+00 | 0.0000E+00 |
| R4 | 1.8990E+00 | −2.4854E+01 | 1.2610E+01 | 0.0000E+00 | 0.0000E+00 | 0.0000E+00 | 0.0000E+00 | 0.0000E+00 |
| R5 | −3.1667E+01 | 2.4784E+04 | −3.9990E+04 | 4.7202E+04 | −3.9767E+04 | 2.2656E+04 | −7.8080E+03 | 1.2255E+03 |
| R6 | 8.8180E+01 | −3.8684E+03 | 5.1978E+03 | −4.9648E+03 | 3.2775E+03 | −1.4147E+03 | 3.5710E+02 | −3.9698E+01 |
| R7 | −2.3965E+00 | 8.2943E+03 | −9.2750E+03 | 7.3812E+03 | −4.0732E+03 | 1.4795E+03 | −3.1778E+02 | 3.0553E+01 |
| R8 | −1.2171E+00 | −5.7166E+01 | 4.4845E+01 | −2.5700E+01 | 1.0354E+01 | −2.7541E+00 | 4.3162E−01 | −3.0070E−02 |
| R9 | −1.0270E+00 | −2.8911E−02 | 6.1137E−03 | −9.0254E−04 | 8.9858E−05 | −5.6390E−06 | 1.9415E−07 | −2.5624E−09 |
| R10 | −1.0102E+00 | 2.9664E−02 | −5.7001E−03 | 7.9796E−04 | −7.8898E−05 | 5.2107E−06 | −2.0593E−07 | 3.6783E−09 |

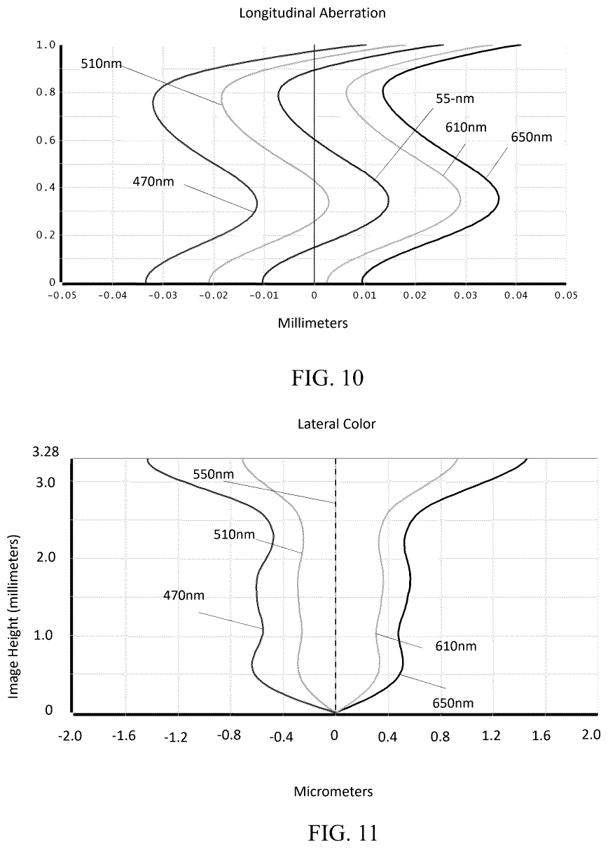

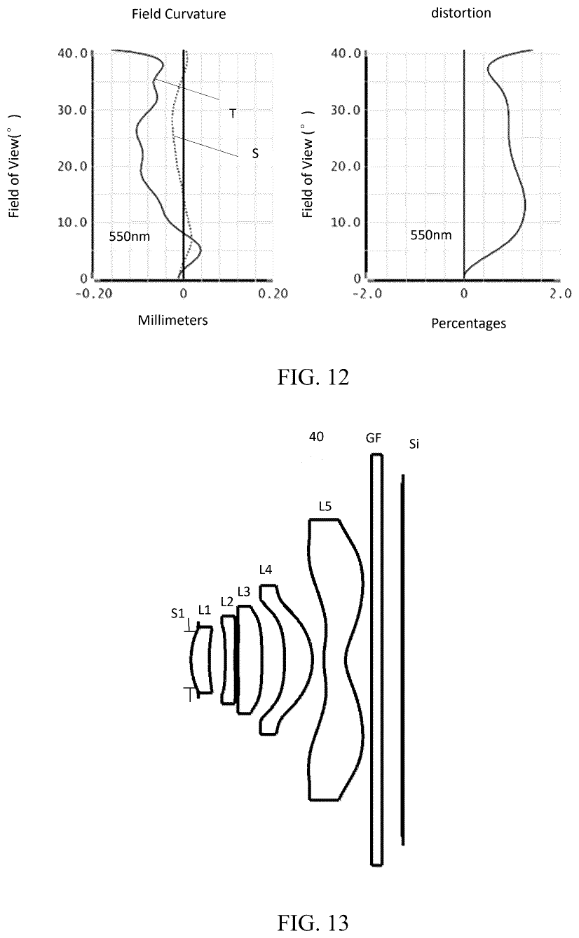

FIG. 10 and FIG. 11 respectively show longitudinal aberration and lateral color of light with wavelengths of 650 nm, 610 nm, 550 nm, 510 nm and 470 nm after passing through the camera optical lens 30 according to Example 3. FIG. 12 shows field curvature and distortion of light with a wavelength of 550 nm after passing through the camera optical lens 30 according to Example 3. The field curvature S in FIG. 12 is the field curvature in a sagittal direction, and T is the field curvature in a meridian direction.

In this Example, the entrance pupil diameter ENPD of the camera optical lens 30 is 1.276 mm, the image height IH at 1.0 field of view is 3.281 mm, the field of view FOV at 1.0 field of view is 81.27°, the image height IHm at MIC field of view is 3.381 mm, and the field of view FOVm at MIC field of view is 82.65°. The camera optical lens 30 meets the design requirements of large aperture, wide-angle and ultra-thinness, effectively correcting both the on-axis and off-axis chromatic aberrations thereof, and has excellent optical performance.

### Example 4

The meaning of the reference signs of Example 4 is the same as that of Example 1.

FIG. 13 shows a camera optical lens 40 according to Example 4 of the present disclosure.

Table 7 and Table 8 show design data of the camera optical lens 40 according to Example 4 of the present disclosure.

TABLE 7

| | R | d | | nd | | vd | |
|---|---|---|---|---|---|---|---|
| S1 | ∞ | d0= | −0.148 | | | | |
| R1 | 1.418 | d1= | 0.368 | nd1 | 1.5444 | vd1 | 55.82 |
| R2 | 3.331 | d2= | 0.323 | | | | |
| R3 | −15.210 | d3= | 0.197 | nd2 | 1.6700 | vd2 | 19.39 |
| R4 | 5.490 | d4= | 0.055 | | | | |
| R5 | 4.315 | d5= | 0.487 | nd3 | 1.5444 | vd3 | 55.82 |
| R6 | −17.033 | d6= | 0.460 | | | | |
| R7 | −3.036 | d7= | 0.560 | nd4 | 1.5444 | vd4 | 55.82 |
| R8 | −1.117 | d8= | 0.228 | | | | |
| R9 | 1.513 | d9= | 0.439 | nd5 | 1.5346 | vd5 | 55.69 |
| R10 | 0.686 | d10= | 0.528 | | | | |
| R11 | ∞ | d11= | 0.210 | ndg | 1.5168 | vdg | 64.17 |
| R12 | ∞ | d12= | 0.420 | | | | |

Table 8 shows aspheric data of each lens in the camera optical lens 40 according to Example 4 of the present disclosure.

TABLE 8

| | Conic Coefficient | Aspheric Coefficient | | | | | | |
|---|---|---|---|---|---|---|---|---|
| | k | A4 | A6 | A8 | A10 | A12 | A14 | A16 |
| R1 | 1.9026E−01 | 2.0572E−02 | 1.6629E−02 | 4.9095E−01 | −4.9809E+00 | 2.3571E+01 | −5.5445E+01 | 4.9958E+01 |
| R2 | 1.4428E+00 | 1.1494E−02 | −1.7490E−01 | 2.9199E+00 | −3.1724E+01 | 2.0089E+02 | −7.7437E+02 | 1.7682E+03 |
| R3 | −3.7251E+02 | −1.9739E−01 | 3.5069E−01 | −5.9792E−01 | −1.5937E+01 | 1.3587E+02 | −5.4754E+02 | 1.2134E+03 |
| R4 | 1.8990E+00 | −3.6978E−01 | 1.5853E+00 | −6.4202E+00 | 1.7845E+01 | −3.0994E+01 | 2.5657E+01 | 5.0535E+00 |
| R5 | −3.1667E+01 | −3.9471E−01 | 2.2357E+00 | −1.9787E+01 | 1.5649E+02 | −9.0977E+02 | 3.7743E+03 | −1.1306E+04 |
| R6 | 8.8180E+01 | −1.1907E−01 | −4.4431E−01 | 5.1168E+00 | −4.0365E+01 | 2.1508E+02 | −7.9339E+02 | 2.0690E+03 |
| R7 | −2.3965E+00 | −1.1356E−01 | 2.1218E+00 | −2.6942E+01 | 1.8186E+02 | −8.0476E+02 | 2.4606E+03 | −5.3326E+03 |
| R8 | −1.2171E+00 | −5.7274E−02 | −1.2903E−01 | 1.2420E+00 | −6.3917E+00 | 1.9121E+01 | −3.8048E+01 | 5.4215E+01 |
| R9 | −1.0270E+00 | −7.0729E−01 | 4.9295E−01 | −6.3062E−03 | −3.3125E−01 | 3.6370E−01 | −2.2822E−01 | 9.6797E−02 |
| R10 | −1.0102E+00 | −1.0460E+00 | 1.3531E+00 | −1.4284E+00 | 1.1616E+00 | −7.1411E−01 | 3.2999E−01 | −1.1442E−01 |
| | Conic Coefficient | Aspheric Coefficient | | | | | | |
| | k | A18 | A20 | A22 | A24 | A26 | A28 | A30 |
| R1 | 1.9026E−01 | 2.4385E+01 | −5.4196E+01 | 0.0000E+00 | 0.0000E+00 | 0.0000E+00 | 0.0000E+00 | 0.0000E+00 |
| R2 | 1.4428E+00 | −2.2008E+03 | 1.1455E+03 | 0.0000E+00 | 0.0000E+00 | 0.0000E+00 | 0.0000E+00 | 0.0000E+00 |
| R3 | −3.7251E+02 | −1.4233E+03 | 6.8513E+02 | 0.0000E+00 | 0.0000E+00 | 0.0000E+00 | 0.0000E+00 | 0.0000E+00 |
| R4 | 1.8990E+00 | −2.4854E+01 | 1.2610E+01 | 0.0000E+00 | 0.0000E+00 | 0.0000E+00 | 0.0000E+00 | 0.0000E+00 |
| R5 | −3.1667E+01 | 2.4784E+04 | −3.9990E+04 | 4.7202E+04 | −3.9767E+04 | 2.2656E+04 | −7.8080E+03 | 1.2255E+03 |
| R6 | 8.8180E+01 | −3.8684E+03 | 5.1978E+03 | −4.9648E+03 | 3.2775E+03 | −1.4147E+03 | 3.5710E+02 | −3.9698E+01 |
| R7 | −2.3965E+00 | 8.2943E+03 | −9.2750E+03 | 7.3812E+03 | −4.0732E+03 | 1.4795E+03 | −3.1778E+02 | 3.0553E+01 |
| R8 | −1.2171E+00 | −5.7166E+01 | 4.4845E+01 | −2.5700E+01 | 1.0354E+01 | −2.7541E+00 | 4.3162E−01 | −3.0070E−02 |
| R9 | −1.0270E+00 | −2.8911E−02 | 6.1137E−03 | −9.0254E−04 | 8.9858E−05 | −5.6390E−06 | 1.9415E−07 | −2.5624E−09 |
| R10 | −1.0102E+00 | 2.9664E−02 | −5.7001E−03 | 7.9796E−04 | −7.8898E−05 | 5.2107E−06 | −2.0593E−07 | 3.6783E−09 |

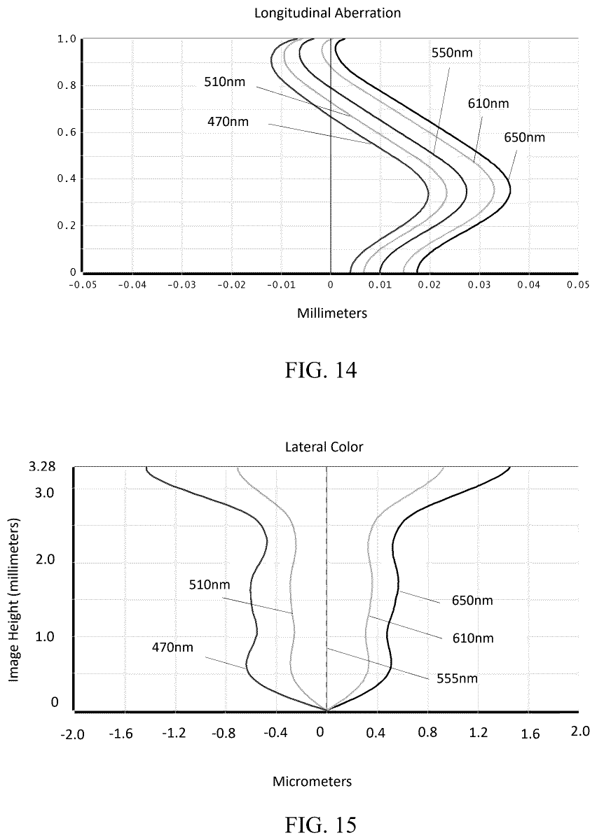

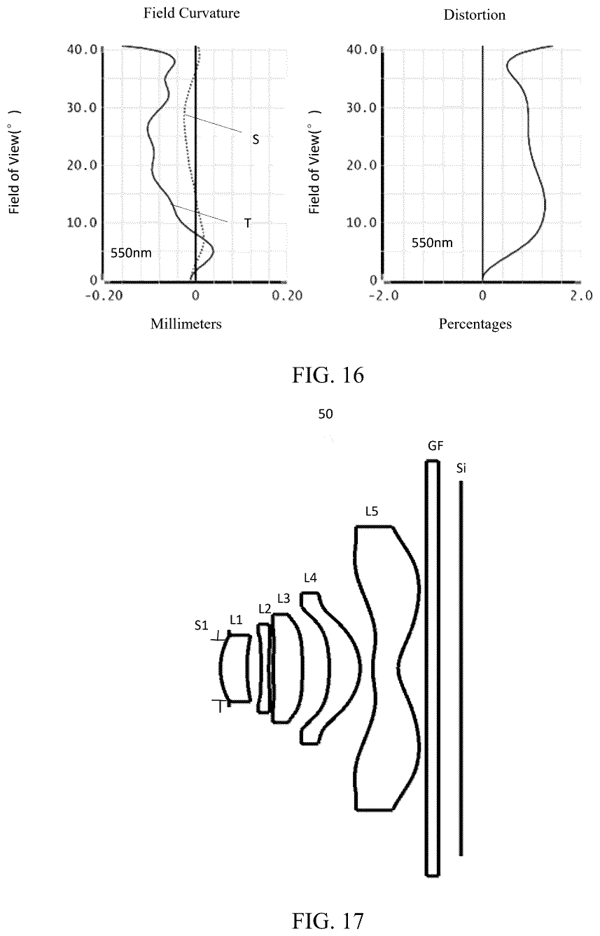

FIG. 14 and FIG. 15 respectively show longitudinal aberration and lateral color of light with wavelengths of 650 nm, 610 nm, 550 nm, 510 nm and 470 nm after passing through the camera optical lens 40 according to Example 4. FIG. 16 shows field curvature and distortion of light with a wavelength of 550 nm after passing through the camera optical lens 40 according to Example 4. The field curvature S in FIG. 16 is the field curvature in a sagittal direction, and T is the field curvature in a meridian direction.

In this Example, the entrance pupil diameter ENPD of the camera optical lens 40 is 1.276 mm, the image height IH at 1.0 field of view is 3.247 mm, the field of view FOV at 1.0 field of view is 90.58°, the image height IHm at MIC field of view is 3.323 mm, and the field of view FOVm at MIC field of view is 91.93°. The camera optical lens 40 meets the design requirements of large aperture, wide-angle and ultra-thinness, effectively correcting both the on-axis and off-axis chromatic aberrations thereof, and has excellent optical performance.

Table 21 appears later to show values of various values in Example 1, Example 2, Example 3 and Example 4 corresponding to parameters specified in the relational expressions.

### COMPARATIVE EXAMPLE

The meaning of the reference signs of Comparative Example is the same as that of Example 1.

FIG. 17 shows a camera optical lens 50 according to Comparative Example.

Table 9 and Table 10 show design data of the camera optical lens 50 according to the Comparative Example.

TABLE 9

| | R | d | | nd | | vd | |
|---|---|---|---|---|---|---|---|
| S1 | ∞ | d0= | −0.150 | | | | |
| R1 | 1.452 | d1= | 0.461 | nd1 | 1.5444 | vd1 | 55.82 |
| R2 | 3.288 | d2= | 0.243 | | | | |
| R3 | 60.109 | d3= | 0.136 | nd2 | 1.6700 | vd2 | 19.39 |
| R4 | 4.607 | d4= | 0.080 | | | | |
| R5 | 5.592 | d5= | 0.504 | nd3 | 1.5444 | vd3 | 55.82 |
| R6 | −12.201 | d6= | 0.468 | | | | |
| R7 | −3.187 | d7= | 0.537 | nd4 | 1.5444 | vd4 | 55.82 |
| R8 | −1.124 | d8= | 0.218 | | | | |
| R9 | 1.520 | d9= | 0.443 | nd5 | 1.5346 | vd5 | 55.69 |
| R10 | 0.680 | d10= | 0.489 | | | | |
| R11 | ∞ | d11= | 0.210 | ndg | 1.5168 | vdg | 64.17 |
| R12 | ∞ | d12= | 0.396 | | | | |

Table 10 shows aspheric data of each lens in the camera optical lens 50 according to Comparative Example.

TABLE 10

| | Conic Coefficient | Aspheric Coefficient | | | | | | |
|---|---|---|---|---|---|---|---|---|
| | k | A4 | A6 | A8 | A10 | A12 | A14 | A16 |
| R1 | 1.9026E−01 | 2.0572E−02 | 1.6629E−02 | 4.9095E−01 | −4.9809E+00 | 2.3571E+01 | −5.5445E+01 | 4.9958E+01 |
| R2 | 1.4428E+00 | 1.1494E−02 | −1.7490E−01 | 2.9199E+00 | −3.1724E+01 | 2.0089E+02 | −7.7437E+02 | 1.7682E+03 |
| R3 | −3.7251E+02 | −1.9739E−01 | 3.5069E−01 | −5.9792E−01 | −1.5937E+01 | 1.3587E+02 | −5.4754E+02 | 1.2134E+03 |
| R4 | 1.8990E+00 | −3.6978E−01 | 1.5853E+00 | −6.4202E+00 | 1.7845E+01 | −3.0994E+01 | 2.5657E+01 | 5.0535E+00 |
| R5 | −3.1667E+01 | −3.9471E−01 | 2.2357E+00 | −1.9787E+01 | 1.5649E+02 | −9.0977E+02 | 3.7743E+03 | −1.1306E+04 |
| R6 | 8.8180E+01 | −1.1907E−01 | −4.4431E−01 | 5.1168E+00 | −4.0365E+01 | 2.1508E+02 | −7.9339E+02 | 2.0690E+03 |
| R7 | −2.3965E+00 | −1.1356E−01 | 2.1218E+00 | −2.6942E+01 | 1.8186E+02 | −8.0476E+02 | 2.4606E+03 | −5.3326E+03 |
| R8 | −1.2171E+00 | −5.7274E−02 | −1.2903E−01 | 1.2420E+00 | −6.3917E+00 | 1.9121E+01 | −3.8048E+01 | 5.4215E+01 |
| R9 | −1.0270E+00 | −7.0729E−01 | 4.9295E−01 | −6.3062E−03 | −3.3125E−01 | 3.6370E−01 | −2.2822E−01 | 9.6797E−02 |
| R10 | −1.0102E+00 | −1.0460E+00 | 1.3531E+00 | −1.4284E+00 | 1.1616E+00 | −7.1411E−01 | 3.2999E−01 | −1.1442E−01 |
| | Conic Coefficient | Aspheric Coefficient | | | | | | |
| | k | A18 | A20 | A22 | A24 | A26 | A28 | A30 |
| R1 | 2.4385E+01 | −5.4196E+01 | 0.0000E+00 | 0.0000E+00 | 0.0000E+00 | 0.0000E+00 | 0.0000E+00 | 2.4385E+01 |
| R2 | −2.2008E+03 | 1.1455E+03 | 0.0000E+00 | 0.0000E+00 | 0.0000E+00 | 0.0000E+00 | 0.0000E+00 | −2.2008E+03 |
| R3 | −1.4233E+03 | 6.8513E+02 | 0.0000E+00 | 0.0000E+00 | 0.0000E+00 | 0.0000E+00 | 0.0000E+00 | −1.4233E+03 |
| R4 | −2.4854E+01 | 1.2610E+01 | 0.0000E+00 | 0.0000E+00 | 0.0000E+00 | 0.0000E+00 | 0.0000E+00 | −2.4854E+01 |
| R5 | 2.4784E+04 | −3.9990E+04 | 4.7202E+04 | −3.9767E+04 | 2.2656E+04 | −7.8080E+03 | 1.2255E+03 | 2.4784E+04 |
| R6 | −3.8684E+03 | 5.1978E+03 | −4.9648E+03 | 3.2775E+03 | −1.4147E+03 | 3.5710E+02 | −3.9698E+01 | −3.8684E+03 |
| R7 | 8.2943E+03 | −9.2750E+03 | 7.3812E+03 | −4.0732E+03 | 1.4795E+03 | −3.1778E+02 | 3.0553E+01 | 8.2943E+03 |
| R8 | −5.7166E+01 | 4.4845E+01 | −2.5700E+01 | 1.0354E+01 | −2.7541E+00 | 4.3162E−01 | −3.0070E−02 | −5.7166E+01 |
| R9 | −2.8911E−02 | 6.1137E−03 | −9.0254E−04 | 8.9858E−05 | −5.6390E−06 | 1.9415E−07 | −2.5624E−09 | −2.8911E−02 |
| R10 | 2.9664E−02 | −5.7001E−03 | 7.9796E−04 | −7.8898E−05 | 5.2107E−06 | −2.0593E−07 | 3.6783E−09 | 2.9664E−02 |

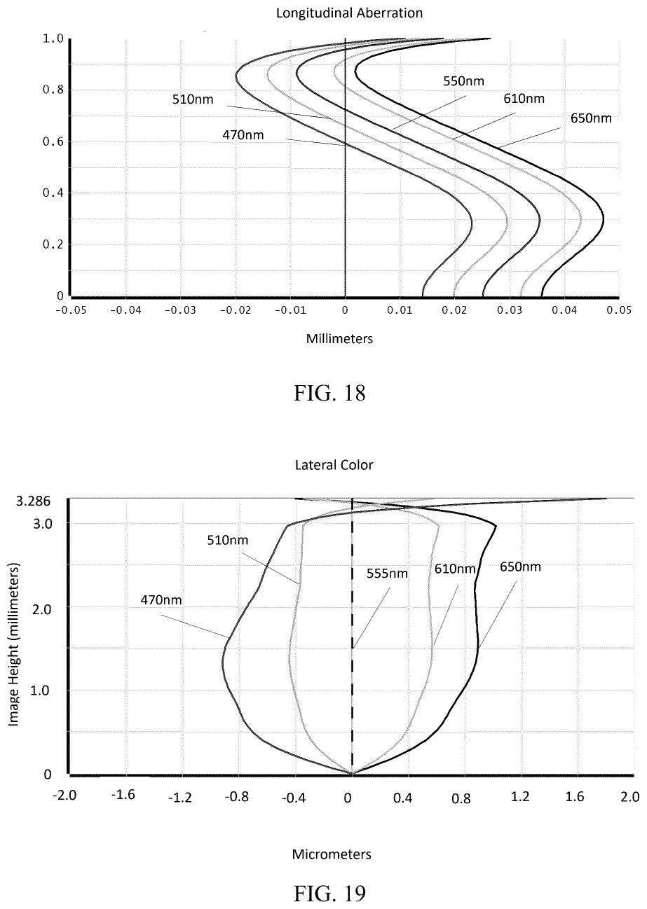

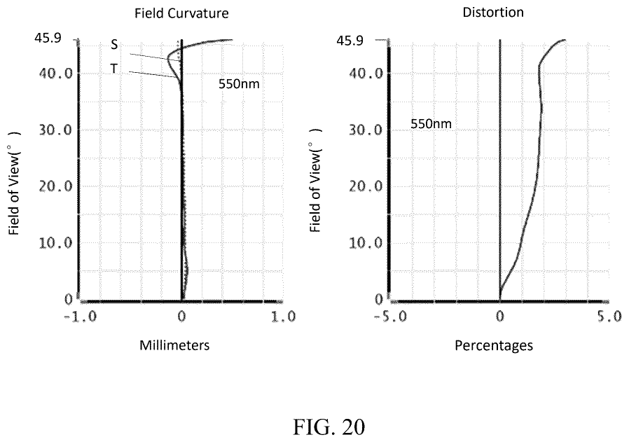

FIG. 18 and FIG. 19 respectively show longitudinal aberration and lateral color of light with wavelengths of 650 nm, 610 nm, 550 nm, 510 nm, and 470 nm after passing through the camera optical lens 50 according to Comparative Example. FIG. 20 shows field curvature and distortion of light with a wavelength of 550 nm after passing through the camera optical lens 50 according to Comparative Example. The field curvature S in FIG. 20 is the field curvature in the sagittal direction, and T is the field curvature in the meridian direction.

Table 11 below lists values corresponding to each relational expression in Comparative Example according to the above relational expressions. The camera optical lens 40 of Comparative Example does not satisfy the above relational expression 0.27≤BF/TTL≤0.34.

In the Comparative Example, the entrance pupil diameter ENPD of the camera optical lens 50 is 1.276 mm, the image height IH at 1.0 field of view is 3.286 mm, the field of view FOV at 1.0 field of view is 91.88°, the image height at MIC field of view IHm is 3.380 mm, and the field of view at MIC field of view FOVm is 93.21°. The camera optical lens 50 does not satisfy the design requirements of the large aperture, wide-angle and ultra-thinness.

TABLE 11

| Parameters | | | | | |
|---|---|---|---|---|---|
| and Relational | Exam- | Exam- | Exam- | Exam- | Comparative |
| Expressions | ple 1 | ple 2 | ple 3 | ple 4 | Example |
| f1/f | 1.39 | 1.49 | 1.30 | 1.34 | 1.41 |
| (R5 + R6)/ | −0.46 | −0.35 | −0.60 | −0.60 | −0.37 |
| (R5 − R6) | | | | | |
| BF/TTL | 0.29 | 0.30 | 0.34 | 0.27 | 0.26 |
| R9/R10 | 2.19 | 2.18 | 2.70 | 2.21 | 2.23 |
| f | 3.11 | 3.00 | 3.71 | 3.16 | 3.09 |
| f1 | 4.31 | 4.47 | 4.83 | 4.23 | 4.37 |
| f2 | −6.46 | −6.63 | −12.65 | −5.93 | −7.37 |
| f3 | 6.89 | 6.59 | 11.45 | 6.35 | 7.09 |
| f4 | 2.81 | 2.70 | 2.77 | 2.93 | 2.91 |
| f5 | −2.91 | −2.93 | −2.43 | −2.87 | −2.81 |
| FNO | 2.43 | 2.35 | 2.91 | 2.48 | 2.42 |
| TTL | 4.26 | 4.20 | 4.61 | 4.28 | 4.185 |
| IH | 3.277 | 3.235 | 3.281 | 3.247 | 3.286 |
| FOV | 91.64 | 93.71 | 81.27 | 90.58 | 91.88 |

Those skilled in the art may understand that the above embodiments are specific embodiments for implementing the present disclosure, and in practical applications, various changes may be made in form and detail without departing from the spirit and scope of the present disclosure.

What is claimed is:

1. A camera optical lens, comprising five lenses sequentially from an object side to an image side: a first lens with positive refractive power, a second lens with negative refractive power, a third lens with positive refractive power, a fourth lens with positive refractive power, and a fifth lens with negative refractive power;
wherein a focal length of the camera optical lens is f, a focal length of the first lens is f1, a curvature radius of an object-side surface of the third lens is R5, a curvature radius of an image-side surface of the third lens is R6, an on-axis distance from an image-side surface of the fifth lens to an image plane is BF, a total optical length from an object-side surface of the first lens to the image plane of the camera optical lens along an optic axis of the camera optical lens is TTL, a curvature radius of an object-side surface of the fifth lens is R9, and a curvature radius of the image-side surface of the fifth lens is R10; and following relational expressions are satisfied:
$$1.3 \leq f 1 / f \leq 1.5 ;$$
$$- 0.6 \; 0 \leq ( R 5 + R 6 ) / ( R 5 - R 6 ) \leq - 0 \text{.35} ;$$
$$0.27 \leq BF / TTL \leq 0.34 ; and$$
$$2.1 \leq R 9 / R 10 \leq 2.70 .$$

2. The camera optical lens as described in claim 1, wherein a focal length of the fourth lens is f4, a focal length of the fifth lens is f5, an air gap between the fourth lens and the fifth lens is T45, and a following relational expression is satisfied:
$$25. 00 \leq ( f 4 - f5 ) / T 45 \leq 60.00 .$$

3. The camera optical lens as described in claim 1, wherein a center thickness of the third lens along the optic axis is T3, an edge thickness of the third lens is ET3, and a following relational expression is satisfied:
$$1. 50 \leq T 3 / ET 3 \leq 2.10 .$$

4. The camera optical lens as described in claim 1, wherein an object-side surface of the first lens is convex in a paraxial region, and an image-side surface of the first lens is concave in the paraxial region; and
a curvature radius of the object-side surface of the first lens is R1, a curvature radius of the image-side surface of the first lens is R2, an on-axis thickness of the first lens is d1, and following relational expressions are satisfied:
$$- 3.25 \leq ( R 1 + R 2 ) / ( R 1 - R 2 ) \leq - 2.48 ; and$$
$$0.06 \leq d 1 / TTL \leq 0.09 .$$

5. The camera optical lens as described in claim 1, wherein an object-side surface of the second lens is concave in a paraxial region, and an image-side surface of the second lens is concave in the paraxial region;
a focal length of the second lens is f2, a curvature radius of the object-side surface of the second lens is R3, a curvature radius of the image-side surface of the second lens is R4, an on-axis thickness of the second lens is d3, and following relational expressions are satisfied:
$$- 3.41 \leq f 2 / f \leq - 1.87 ;$$
$$0.47 \leq ( R 3 + R 4 ) / ( R 3 - R 4 ) \leq 0.88 ; and$$
$$0.02 \leq d 3 / TTL \leq 0.05 .$$

6. The camera optical lens as described in claim 1, wherein the object-side surface of the third lens is convex in a paraxial region, and the image-side surface of the third lens is convex in the paraxial region;
a focal length of the third lens is f3, an on-axis thickness of the third lens is d5 and following relational expressions are satisfied:
$$2. \leq f 3 / f \leq 3.09 ; and$$
$$0.11 \leq d 5 / TTL \leq 0.12 .$$

7. The camera optical lens according to claim 1, wherein an object-side surface of the fourth lens is concave in the paraxial region, and an image-side surface of the fourth lens is convex in the paraxial region; and
a focal length of the fourth lens is f4, a curvature radius of the object-side surface of the fourth lens is R7, a curvature radius of the image-side surface of the fourth lens is R8, an on-axis thickness of the fourth lens is d7, and following relational expressions are satisfied:
$$0.74 \leq f 4 / f \leq 0.93 ;$$
$$1. 87 \leq ( R 7 + R 8 ) / ( R 7 - R 8 ) \leq 2.17 ; and$$
$$0.12 \leq d 7 / TTL \leq 0.14 .$$

8. The camera optical lens as described in claim 1, wherein the object-side surface of the fifth lens is convex in a paraxial region, and the image-side surface of the fifth lens is concave in the paraxial region;
a focal length of the fifth lens is f5, an on-axis thickness of the fifth lens is d9, and following relational expressions are satisfied:
$$- 0.98 \leq f 5 / f \leq - 0 \text{.65} ;$$
$$2.17 \leq ( R 9 + R 10 ) / ( R 9 - R 10 ) \leq 2.71 ; and$$
$$0.1 \leq d 9 / TTL \leq 0.12 .$$

9. The camera optical lens as described in claim 1, wherein an image height of the camera optical lens is IH, and a following relational expression is satisfied:
$$TTL / IH \leq 1.41 .$$

10. The camera optical lens as described in claim 1, wherein a field of view of the camera optical lens is FOV, and a following relational expression is satisfied:
$$81.27 \leq FOV .$$
